(19) United States
(12) Patent Application Publication
(10) Pub. No.: US 2016/0048389 A1
(43) Pub. Date: Feb. 18, 2016

(54) SYSTEM AND METHOD FOR SUPPORTING PART REPLACEMENT

(71) Applicant: Deepaganesh Paulraj, Bangalore (IN)

(72) Inventor: Deepaganesh Paulraj, Bangalore (IN)

(21) Appl. No.: 14/457,911

(22) Filed: Aug. 12, 2014

(51) Int. Cl. G06F 9/44; G06F 9/445

(52) U.S. Cl. CPC G06F 8/71; G06F 9/44536

(57) ABSTRACT

Methods and systems for supporting part replacement by an access controller of an information handling system may involve determining whether a firmware version of a hardware component installed on the information handling system matches a stored firmware version. When indicated, the installed firmware on the hardware component may be read and packaged into a firmware package. The firmware package may be stored by the access controller on an embedded storage partition to support future automatic part replacement of new instances of the hardware component.

### BACKGROUND

1. Field of the Disclosure

This disclosure relates generally to information handling systems and more particularly to systems and methods for supporting part replacement.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The use of access controllers in information handling systems has increased in recent years. Broadly speaking, an access controller may be a device, system, or apparatus for remote monitoring or management of an information handling system. An access controller may be enabled to use a so-called ‘out-of-band’ network interface that is physically isolated from an ‘in-band’ network interface used generally for non-management communications. The access controller may include, or be an integral part of, a baseboard management controller (BMC), a Dell Remote Access Controller (DRAC), or an Integrated Dell Remote Access Controller (iDRAC).

The access controller may be a secondary information handling system embedded in the information handling system. This secondary information handling system, in the form of the access controller, may include lifecycle management functionality for various components of the information handling system, including hardware and software components. For hardware components, lifecycle management functionality may include a part replacement feature where newly introduced hardware components are automatically configured for use. In particular, when a new hardware component replaces a previous hardware component, the part replacement feature of the lifecycle management functions may perform an automatic firmware update in an effort to insure that the new hardware component operates in the same manner, and with the same device settings, as the previous hardware component. Such lifecycle management functionality, among other functions, may be provided by a Lifecycle Controller operating within iDRAC, for example.

In conventional access controllers having the part replacement feature, during a factory installation process, the hardware components of the information handling system will be updated with the latest firmware. As a result, a copy of the currently installed firmware will be stored in an embedded storage partition, and thus, will be available to the access controller upon shipment of the information handling system from the factory. In this situation, the part replacement feature of the access controller with operate correctly, because the stored copy of the current firmware will match the actual firmware on the hardware component. Without the stored copy of the actual firmware as a reference, the part replacement feature will be unable to perform a firmware update.

However, the embedded storage partition may only store the currently installed firmware for hardware components installed at the time of factory shipment. If a different hardware component that was not previously installed is introduced at a later time into the information handling system, as may often occur during normal operation, the part replacement feature will not support the different hardware component, because there will be no stored copy of the current firmware available to the access controller.

Also, in situations where the hardware component is replaced when the part replacement feature is disabled, then when the part replacement feature is subsequently turned on, the part replacement feature will not be performed on that device. Additionally, when the firmware of the hardware component is updated through an operating system process or application, then the part replacement feature will not be performed on that device.

### SUMMARY

In one aspect, a disclosed method includes performing, by an access controller upon starting of an information handling system, a system inventory to discover a hardware component installed in the information handling system. The system inventory may include determining a first firmware version installed on the hardware component. The method may include determining whether the hardware component is a supported device for the information handling system. When the hardware component is a supported device, the method may include determining whether an embedded storage partition accessible to the access controller stores a firmware package for the hardware component. When the embedded storage partition stores the firmware package, the method may further include determining a second firmware version of the firmware package. When the embedded storage partition does not store the firmware package or when the second firmware version does not match the first firmware version, the method may include reading, from the hardware component, installed firmware corresponding to the first firmware version.

In certain embodiments, the method includes packaging the installed firmware as an installed firmware package, and storing the installed firmware package in the embedded storage partition, while the installed firmware package is indexed to the hardware component. When the hardware component is replaced with a new hardware component and the new hardware component is the same supported device as the hardware component, the method may include updating the firmware of the new hardware component using the installed firmware package.

Another disclosed aspect includes an information handling system, comprising a processor subsystem having access to a first memory, and an access controller comprising a secondary processor having access to a second memory, the second memory including an embedded storage partition and the second memory storing instructions executable by the secondary processor.

A further disclosed aspect includes an access controller for an information handling system having a primary processor and a primary memory, the access controller comprising a secondary processor having access to a second memory, the second memory including an embedded storage partition and the second memory storing instructions executable by the secondary processor.

An additional disclosed aspect includes an article of manufacture comprising a non-transitory computer-readable medium storing instructions executable by a secondary processor, while an information handling system comprises a processor subsystem and the second processor.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system for supporting part replacement, as disclosed herein;

FIG. 2 is a flowchart depicting selected elements of an embodiment of a method for supporting part replacement, as disclosed herein; and

FIG. 3 is a flowchart depicting selected elements of an embodiment of a method for supporting part replacement, as disclosed herein.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Additionally, the information handling system may include firmware for controlling and/or communicating with, for example, hard drives, network circuitry, memory devices, I/O devices, and other peripheral devices. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

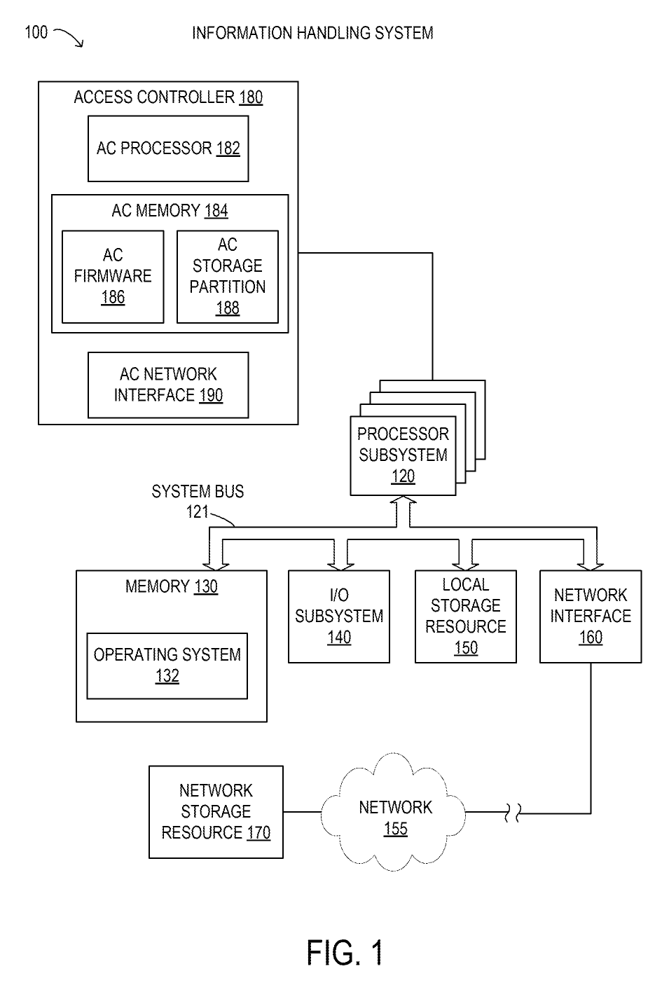

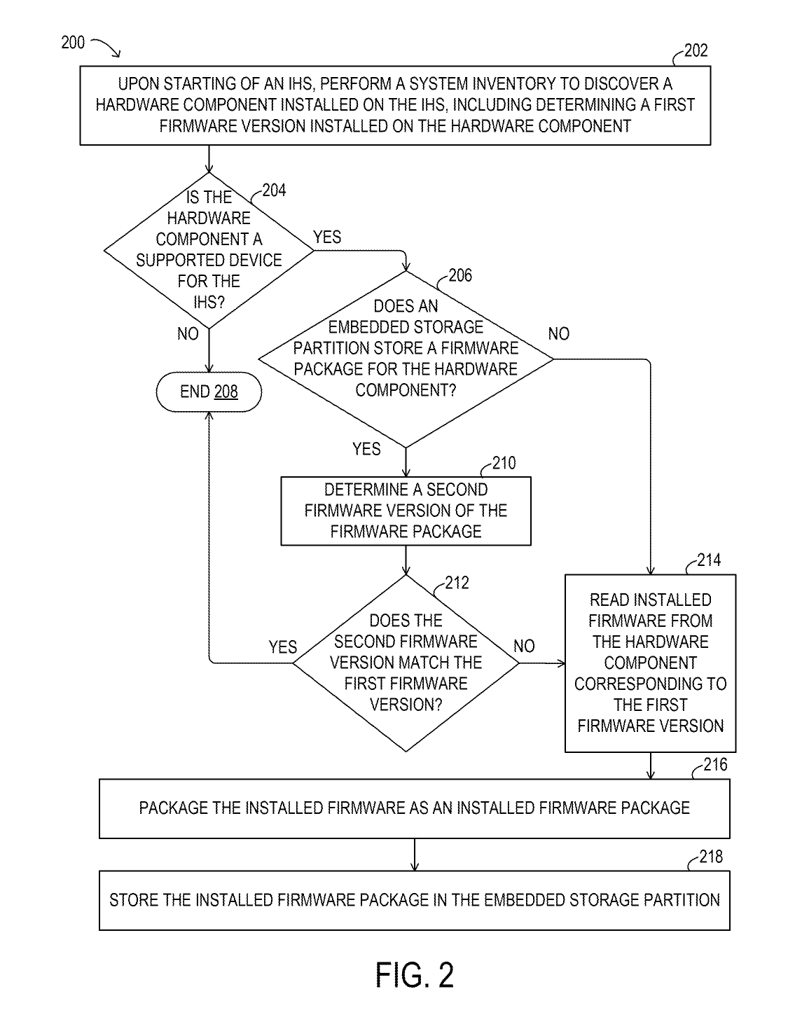

Particular embodiments are best understood by reference to FIGS. 1 and 2 wherein like numbers are used to indicate like and corresponding parts.

Turning now to the drawings, FIG. 1 illustrates a block diagram depicting selected elements of an embodiment of information handling system 100. Also shown with information handling system 100 are external or remote elements, namely, network 155 and network storage resource 170.

As shown in FIG. 1, components of information handling system 100 may include, but are not limited to, processor subsystem 120, which may comprise one or more processors, and system bus 121 that communicatively couples various system components to processor subsystem 120 including, for example, memory 130, I/O subsystem 140, local storage resource 150, and network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network 155. Network interface 160 may enable information handling system 100 to communicate over network 155 using a suitable transmission protocol and/or standard, including, but not limited to, transmission protocols and/or standards enumerated below with respect to the discussion of network 155. In some embodiments, network interface 160 may be communicatively coupled via network 155 to network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 155 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, or any combination thereof. In certain embodiments, information handling system 100 and network 155 may be included in a rack domain.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory 130 and/or another component of physical hardware 102). In the same or alternative embodiments, processor subsystem 120 may interpret and/or execute program instructions and/or process data stored remotely (e.g., in a network storage resource).

Also in FIG. 1, memory 130 may comprise a system, device, or apparatus operable to retain and/or retrieve program instructions and/or data for a period of time (e.g., computer-readable media). As shown in the example embodiment of FIG. 1, memory 130 stores operating system 132, which may represent instructions executable by processor subsystem 120 to operate information handling system 100 after booting. It is noted that in different embodiments, operating system 132 may be stored at network storage resource 170 and may be accessed by processor subsystem 120 via network 155 Memory 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as information handling system 100, is powered down.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. For example, local storage resource 150 may store executable code in the form of program files that may be loaded into memory 130 for execution, such as operating system 132. In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. For example, I/O subsystem 140 may include a Peripheral Component Interconnect Express (PCI-E) interface that is supported by processor subsystem 120. In certain embodiments, I/O subsystem 140 may comprise a touch panel and/or a display adapter. The touch panel (not shown) may include circuitry for enabling touch functionality in conjunction with a display (not shown) that is driven by display adapter (not shown).

Also shown in FIG. 1 is access controller (AC) 180, which may include AC processor 182 as a second processor included with information handling system 100 for certain management tasks. AC processor 182 may have access to AC memory 184, which may store AC firmware 186, representing instructions executable by AC processor 182. Also shown stored in AC memory 184 is AC storage partition 188, which may represent an embedded storage partition for access controller 180. AC firmware 186 may represent pre-boot instructions executable by AC processor 182, for example, for preparing information handling system 100 to boot by activating various hardware components in preparation of launching operating system 132 for execution (also referred to as a basic input/output system (BIOS)). In certain embodiments, AC firmware 186 includes a Unified Extensible Firmware Interface (UEFI) according to a specification promulgated by the UEFI Forum (uefi.org). Also included with access controller 180 is AC network interface 190, which may be a secondary network interface to network interface 160. AC network interface 190 may provide ‘out-of-‘band’ network access to access controller 180, for example, even when network interface 160 is unavailable. Thus, access controller 180 may execute AC firmware 186 on AC processor 182 and use AC network interface 190 even when other components in information handling system 100 are inoperable. It is noted that, in certain embodiments, access controller 180 may represent an instance of iDRAC while AC firmware 186 may include a Lifecycle Controller.

In operation, when information handling system 100 is powered on, booted, or rebooted (i.e., started or restarted), AC firmware 186 may perform a system inventory to discover a hardware component installed on information handling system 100. The hardware component may be newly installed on information handling system 100 when AC firmware 186 discovers the hardware component. A first firmware version installed on the hardware component may be identified. After determining that the hardware component is a supported device, for example by checking a list of supported devices, AC firmware 186 may check whether AC memory 184, or specifically, AC storage partition 188, stores a firmware package for the hardware component. When the firmware package for the hardware component is detected, for example, in AC storage partition 188, a second firmware version for the stored firmware package may be identified. When no firmware package is present or the second firmware version does not match the first firmware version, AC firmware 186 may read the firmware installed on the hardware component corresponding to the first firmware version. The installed firmware may be packaged as an installed firmware package and the installed firmware package may be stored in AC storage partition 188. As used herein, a ‘firmware package’ refers to an installation package usable to install firmware and including a firmware binary image.

At a later time, when the hardware component is replaced with a new hardware component that is the same supported device, AC firmware 186 may proceed to automatically update the firmware of the new hardware component using the installed firmware package. It is noted that updating the firmware on the new hardware component may include determining if an installed firmware on the new hardware component matches the installed firmware package. In instances where the installed firmware on the new hardware component is a newer firmware version than the installed firmware package generated by the process described above, AC firmware 186 may update the installed firmware package in a similar process as described with respect to the hardware component that was replaced.

Referring now to FIG. 2, a block diagram of selected elements of an embodiment of method 200 for supporting part replacement, as described herein, is depicted in flowchart form. Method 200 may be performed using information handling system 100 (see FIG. 1) and, in particular, by AC firmware 186 of access controller 180 executing on AC processor 182. It is noted that certain operations described in method 200 may be optional or may be rearranged in different embodiments.

Upon starting of an information handling system (IHS), method 200 begins by performing (operation 202) a system inventory to discover a hardware component installed on the IHS, including determining a first firmware version installed on the hardware component. As used herein, ‘starting’ of the IHS may include booting, rebooting, initial power on, or restarting while powered on. The hardware component may be a hardware device installed on the IHS. In various embodiments, the hardware component may be selected from at least one of: a network interface controller, a storage controller, a system bus controller, a memory device, and a storage device. In some embodiments, the hardware component is a Peripheral Component Interconnect Express (PCI-E) device. A decision is made whether the hardware component is (operation 204) a supported device for the IHS. The decision in operation 204 may be made based on a match with a list of supported devices for the IHS. The list of supported devices may be stored locally in an embedded storage partition (i.e., AC storage partition 188) accessible to the access controller. The list of supported storage devices may be accessed via a network (i.e., using AC network interface 190). When the result of operation 204 is NO, method 200 ends at operation 208. When the result of operation 204 is YES, a decision is made whether an embedded storage partition stores (operation 206) a firmware package for the hardware component. When the result of operation 206 is YES, a second firmware version of the firmware package is determined (operation 210). Then, a decision is made whether the second firmware version matches (operation 212) the first firmware version. When the result of operation 212 is YES, method 200 ends at operation 208. When the result of operation 212 is NO or when the result of operation 206 is NO, installed firmware is read (operation 214) from the hardware component corresponding to the first firmware version. The installed firmware is packaged (operation 216) as an installed firmware package. The installed firmware package is stored (operation 218) in the embedded storage partition. The installed firmware package may be stored under an index to the hardware component. The installed firmware package may be stored in a directory labeled ‘installed’, which is different from a directory labeled ‘current’ and different from a directory labeled ‘previous’.

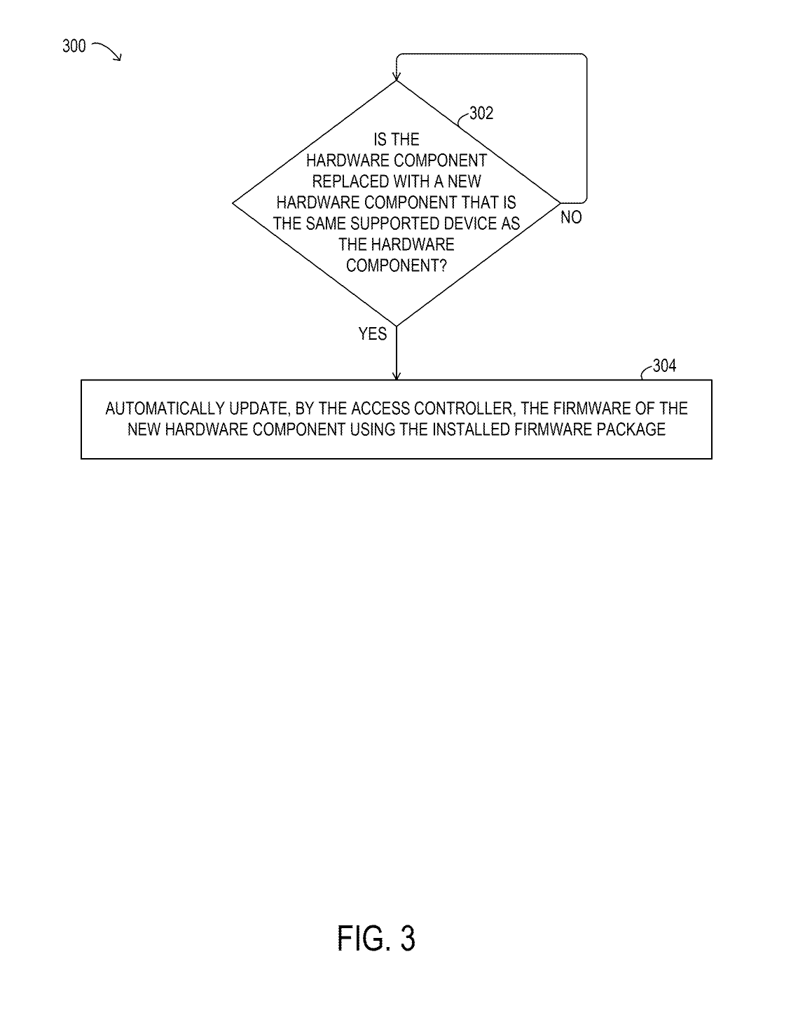

Referring now to FIG. 3, a block diagram of selected elements of an embodiment of method 300 for supporting part replacement, as described herein, is depicted in flowchart form. Method 300 may be performed using information handling system 100 (see FIG. 1) and, in particular, by AC firmware 186 of access controller 180 executing on AC processor 182. It is noted that certain operations described in method 300 may be optional or may be rearranged in different embodiments. Method 300 may be performed after method 200 (see FIG. 2).

Method 300 begins with a decision whether the hardware component is replaced (operation 302) with a new hardware component that is the same supported device as the hardware component. When the result of operation 302 is NO, method 300 may loop back to operation 302 and wait until the result of operation 302 is YES. When the result of operation 302 is YES, the firmware of the new hardware component is automatically updated (operation 304) by the access controller using the installed firmware package. Automatic updating of firmware of the new hardware device by the access controller may be performed upon starting the IHS, and may include checking the embedded storage partition for a newer version of the firmware prior to updating. When the new hardware component has a newer firmware than is stored on the embedded storage partition, the access controller may execute method 200 in a similar manner for the new hardware component as described with respect to the hardware component.

As disclosed herein, methods and systems for supporting part replacement by an access controller of an information handling system may involve determining whether a firmware version of a hardware component installed on the information handling system matches a stored firmware version. When indicated, the installed firmware on the hardware component may be read and packaged into a firmware package. The firmware package may be stored by the access controller on an embedded storage partition to support future automatic part replacement of new instances of the hardware component.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
performing, by an access controller upon starting of an information handling system, a system inventory to discover a hardware component installed in the information handling system, wherein the system inventory includes determining a first firmware version installed on the hardware component;
determining whether the hardware component is a supported device for the information handling system;
when the hardware component is a supported device, determining whether an embedded storage partition accessible to the access controller stores a firmware package for the hardware component;
when the embedded storage partition stores the firmware package, determining a second firmware version of the firmware package;
when the embedded storage partition does not store the firmware package or when the second firmware version does not match the first firmware version, reading, from the hardware component, installed firmware corresponding to the first firmware version.

2. The method of claim 1, further comprising:
packaging the installed firmware as an installed firmware package; and
storing the installed firmware package in the embedded storage partition, wherein the installed firmware package is indexed to the hardware component.

3. The method of claim 2, further comprising:
when the hardware component is replaced with a new hardware component, wherein the new hardware component is the same supported device as the hardware component, updating the firmware of the new hardware component using the installed firmware package.

4. The method of claim 3, wherein updating the firmware of the new hardware component is performed automatically by the access controller when the new hardware component is detected

5. The method of claim 1, wherein the hardware component is a Peripheral Component Interconnect Express (PCI-E) device.

6. The method of claim 1, wherein the hardware component is selected from at least one of:
a network interface controller;
a storage controller;
a system bus controller;
a memory device; and
a storage device.

7. An information handling system, comprising:
a processor subsystem having access to a first memory;
an access controller comprising a secondary processor having access to a second memory, the second memory including an embedded storage partition and the second memory storing instructions executable by the secondary processor to:
perform, upon starting of the information handling system, a system inventory to discover a hardware component installed in the information handling system, wherein the system inventory includes determining a first firmware version installed on the hardware component;
determine whether the hardware component is a supported device for the information handling system;
when the hardware component is a supported device, determine whether the embedded storage partition stores a firmware package for the hardware component;
when the embedded storage partition stores the firmware package, determining a second firmware version of the firmware package;
when the embedded storage partition does not store the firmware package or when the second firmware version does not match the first firmware version, reading, from the hardware component, installed firmware corresponding to the first firmware version.

8. The information handling system of claim 7, further comprising instructions executable by the secondary processor to:
package the installed firmware as an installed firmware package; and
store the installed firmware package in the embedded storage partition, wherein the installed firmware package is indexed to the hardware component.

9. The information handling system of claim 8, further comprising instructions executable by the secondary processor to:
when the hardware component is replaced with a new hardware component, wherein the new hardware component is the same supported device as the hardware component, update the firmware of the new hardware component using the installed firmware package.

10. The information handling system of claim 9, wherein the instructions to update the firmware of the new hardware component are automatically executed by the secondary processor when the new hardware component is detected.

11. The information handling system of claim 7, wherein the hardware component is a Peripheral Component Interconnect Express (PCI-E) device.

12. The information handling system of claim 7, wherein the hardware component is selected from at least one of:
a network interface controller;
a storage controller;
a system bus controller;
a memory device; and
a storage device.

13. The information handling system of claim 7, wherein the instructions stored on the second memory comprise a unified extensible firmware interface.

14. An access controller for an information handling system having a primary processor and a primary memory, the access controller comprising:
a secondary processor having access to a second memory, the second memory including an embedded storage partition and the second memory storing instructions executable by the secondary processor to:
perform, upon starting of the information handling system, a system inventory to discover a hardware component installed in the information handling system, wherein the system inventory includes determining a first firmware version installed on the hardware component;
determine whether the hardware component is a supported device for the information handling system;
when the hardware component is a supported device, determine whether the embedded storage partition stores a firmware package for the hardware component;
when the embedded storage partition stores the firmware package, determining a second firmware version of the firmware package;
when the embedded storage partition does not store the firmware package or when the second firmware version does not match the first firmware version, reading, from the hardware component, installed firmware corresponding to the first firmware version.

15. The access controller of claim 14, further comprising instructions executable by the secondary processor to:
package the installed firmware as an installed firmware package; and
store the installed firmware package in the embedded storage partition, wherein the installed firmware package is indexed to the hardware component.

16. The access controller of claim 15, further comprising instructions executable by the secondary processor to:
when the hardware component is replaced with a new hardware component, wherein the new hardware component is the same supported device as the hardware component, update the firmware of the new hardware component using the installed firmware package.

17. The access controller of claim 16, wherein the instructions to update the firmware of the new hardware component are automatically executed by the secondary processor when the new hardware component is detected.

18. The access controller of claim 14, wherein the hardware component is a Peripheral Component Interconnect Express (PCI-E) device.

19. The access controller of claim 14, wherein the hardware component is selected from at least one of:
a network interface controller;
a storage controller;
a system bus controller;
a memory device; and
a storage device.

20. The access controller of claim 14, wherein the instructions stored on the second memory comprise a unified extensible firmware interface.
